(19) United States
(12) Patent Application Publication
(10) Pub. No.: US 2014/0253454 A1
(43) Pub. Date: Sep. 11, 2014

(54) KEYBOARD WITH INTEGRATED TOUCH SENSING

(71) Applicant: AlSentis, LLC, Holland, MI (US)

(72) Inventor: David W. Caldwell, Holland, MI (US)

(21) Appl. No.: 14/203,880

(22) Filed: Mar. 11, 2014

Related U.S. Application Data
(60) Provisional application No. 61/776,230, filed on Mar. 11, 2013.

(51) Int. Cl. G06F 3/02

(52) U.S. Cl. CPC G06F 3/0219
USPC 345/168

(57) ABSTRACT

A keyboard device and a related method of operation are provided. The keyboard device includes a compressible touch substrate having a plurality of keys, a support substrate underlying the touch substrate, and a plurality of electrodes between the touch substrate and the support substrate. The keyboard is adapted to detect movement of an object against the touch substrate and along the touch substrate. The keyboard is further adapted to classify such movement as a key selection or as a touch gesture based on the degree of deflection of the compressible touch substrate.

### BACKGROUND OF THE INVENTION

The present invention relates to a keyboard with integrated touch sensing and a related method of operation.

Computer keyboards have been in use almost with the invention of the personal computer. Keyboards to date are still the predominate component used to input text and numerical information into personal computers and computing devices such as mobile phones, laptops, etc.

With the popular implementation of touch technology in transparent touchscreens, the computer interfaces have greatly improved. Computer interfaces are used in mobile phones, smartphones, computer tablets, notebooks, automatic teller machines, and copying machines. Gesturing is a predominate mode for the intuitive input of information and commands for the selection and input to applications on these devices. Even so, there is still a need for the input of text and numerical information on many of these devices. Where text and numerical information is needed for the operation of these devices and/or their applications, keyboards are still used. These keyboards may utilize simple twelve-input keyboards for standard mobile phones to keyboards in excess of one-hundred inputs for computers.

Many times the keyboards are of a single input-per-switch construction. For instance, if there are twelve inputs on a mobile phone there are twelve switches, where each switch would provide an “on” or “off” binary input. More recently, many devices include a touch screen for inputting of non-textual or non-numerical information. Touch screens often simulate a keyboard for the input of textual or numerical information. While touch screens having a simulated keyboard are widely accepted, there remains a continued need for an improved device that combines the functions of a touchpad or touchscreen with the functional switch input of a keyboard.

### SUMMARY OF THE INVENTION

A keyboard device and a related method of operation are provided. The keyboard device includes a compressible touch substrate having a plurality of keys, a support substrate underlying the touch substrate, and a plurality of electrodes between the touch substrate and the support substrate. The keyboard is adapted to detect movement of an object against the touch substrate and movement of an object along the touch substrate. The keyboard is further adapted to classify such movement as a key selection or as a touch gesture based on the deflection of the compressible touch substrate.

In one embodiment, the touch substrate is substantially continuous, being formed of a shape-memory material. The touch substrate includes a touch surface adapted to locally flex in response to movement of an object against the touch substrate in a direction orthogonal to the touch substrate. The touch surface returns to an unflexed condition in response to movement of the object away from the touch substrate. The touch surface remains substantially planar during movement of an object along the touch substrate in a direction parallel to the surface of the touch substrate.

In another embodiment, the touch substrate includes a plurality of depressible keys that are spaced apart from each other. The keys are spaced apart by a groove or an indentation between adjacent ones of the plurality of keys. The keys can include an internal resilient element, for example a spring or a gaseous fluid. Each of the plurality of electrodes is coextensive with an overlying one of the plurality of keys. A bias electrode is optionally positioned between the plurality of electrodes and the support substrate. A plurality of spacers are further optionally positioned between the touch substrate and the support substrate, optionally immediately adjacent the bias electrode.

In another embodiment, a plurality of resilient elements is disposed between a substantially rigid touch substrate and a substantially rigid support substrate. The plurality of resilient elements can include compressible spacers or compression springs, for example. A plurality of electrodes is supported at the support substrate, each including an output coupled to a processing unit. The processing unit is adapted to detect the movement of the substantially rigid touch substrate toward the support substrate based on the output of the plurality of electrodes. The keyboard is further adapted to classify such movement as a key selection or as a touch gesture based on the amount of movement of the substantially rigid touch substrate toward the support substrate.

In another embodiment, a method of operation is provided. The method includes measuring the capacitance of at least one of the plurality of electrodes, determining a deflection of the compressible touch substrate based on the measured capacitance, and distinguishing between a key selection and a touch gesture based on the determined deflection of the compressible touch substrate. Key selection can include at least a predetermined deflection of the compressible touch substrate, while the touch gesture can include movement onto or along the compressible touch substrate without achieving the predetermined deflection. Movement of an object onto or along the substrate can indicate a tap function, a swipe function, a zoom function, a pan function, a fling function, and a scroll function, for example.

The embodiments therefore provide a dual use keyboard that is operable to accept key inputs and operable to accept touch gestures. The embodiments may be implemented in combination with capacitive sensing and time domain differential capacitive sensing. For example, the embodiments may be implemented in combination with the sensing techniques and sensing circuits set forth in U.S. Patent Application Publication 2012/0068760 to Caldwell et al entitled “Apparatus and Method for Determining a Touch Input,” PCT Patent Application Publication WO2013/163496 to Caldwell et al entitled “Apparatus and Method for Determining a Stimulus, Including a Touch Input and a Stylus Input,” U.S. Provisional Application 61/875,961 to Caldwell et al entitled “Time Domain Differential Techniques to Characterize Various Stimuli,” and U.S. Provisional Application 61/947,641 to Caldwell entitled “Simultaneous Sensing Circuits for Time Domain Differential and Other Electric Field Sensing,” the disclosures of which are incorporated by reference in their entirety.

These and other features and advantages of the present invention will become apparent from the following description of the invention, when viewed in accordance with the accompanying drawings and appended claims.

### BRIEF DESCRIPTION OF THE DRAWINGS

FIG. 1 is a first cross-sectional view of a keyboard in accordance with a first embodiment;

FIG. 2 is a second cross-sectional view of a keyboard in accordance with the first embodiment, illustrating selection of a key;

FIG. 3 is a top plan view of the keyboard of FIGS. 1-2;

FIG. 4 is a first cross-sectional view of a keyboard in accordance with a second embodiment;

FIG. 5 is a second cross-sectional view of a keyboard in accordance with the second embodiment, illustrating selection of a key;

FIG. 6 is a top plan view of the keyboard of FIGS. 4-5;

FIG. 7 is a first cross-sectional view of a keyboard in accordance with a third embodiment;

FIG. 8 is a second cross-sectional view of a keyboard in accordance with the third embodiment, illustrating selection of a key;

FIG. 9 is a top plan view of the keyboard of FIGS. 7-8;

FIG. 10 is a first cross-sectional view of a keyboard in accordance with a fourth embodiment;

FIG. 11 is a second cross-sectional view of a keyboard in accordance with the fourth embodiment, illustrating selection of a key;

FIG. 12 is a top plan view of the keyboard of FIGS. 10-11;

FIG. 13 is a first cross-sectional view of a keyboard in accordance with a fifth embodiment;

FIG. 14 is a second cross-sectional view of a keyboard in accordance with the fifth embodiment, illustrating selection of a key;

FIG. 15 is a top plan view of the keyboard of FIGS. 13-14;

FIG. 16 is a first cross-sectional view of a keyboard in accordance with a sixth embodiment;

FIG. 17 is a second cross-sectional view of a keyboard in accordance with the sixth embodiment, illustrating selection of a key;

FIG. 18 is a top plan view of the keyboard of FIGS. 16-17;

FIG. 19 is a first cross-sectional view of a keyboard in accordance with a sixth embodiment;

FIG. 20 is a second cross-sectional view of a keyboard in accordance with the sixth embodiment, illustrating selection of a key;

FIG. 21 is a top plan view of the keyboard of FIGS. 19-20;

FIG. 22 is a first cross-sectional view of a keyboard in accordance with a seventh embodiment;

FIG. 23 is a second cross-sectional view of a keyboard in accordance with the seventh embodiment, illustrating selection of a key; and

FIG. 24 is a top plan view of the keyboard of FIGS. 22-23.

### DESCRIPTION OF THE CURRENT EMBODIMENTS

The current embodiments generally relate to a dual-use keyboard and a related method of operation. As set forth below, the dual-use keyboard is operable in a “keypad mode” and operable in a “touchpad mode” based on the degree of deflection of a depressible touch substrate. In keypad mode, the dual-use keyboard detects the two-dimensional location(s) of an object for selection of one or more keys on the keyboard. In touchpad mode, the dual-use keyboard detects the two-dimensional location(s) of an object for cursor control, swipe, scroll, tap and other touch gestures.

I. System Overview

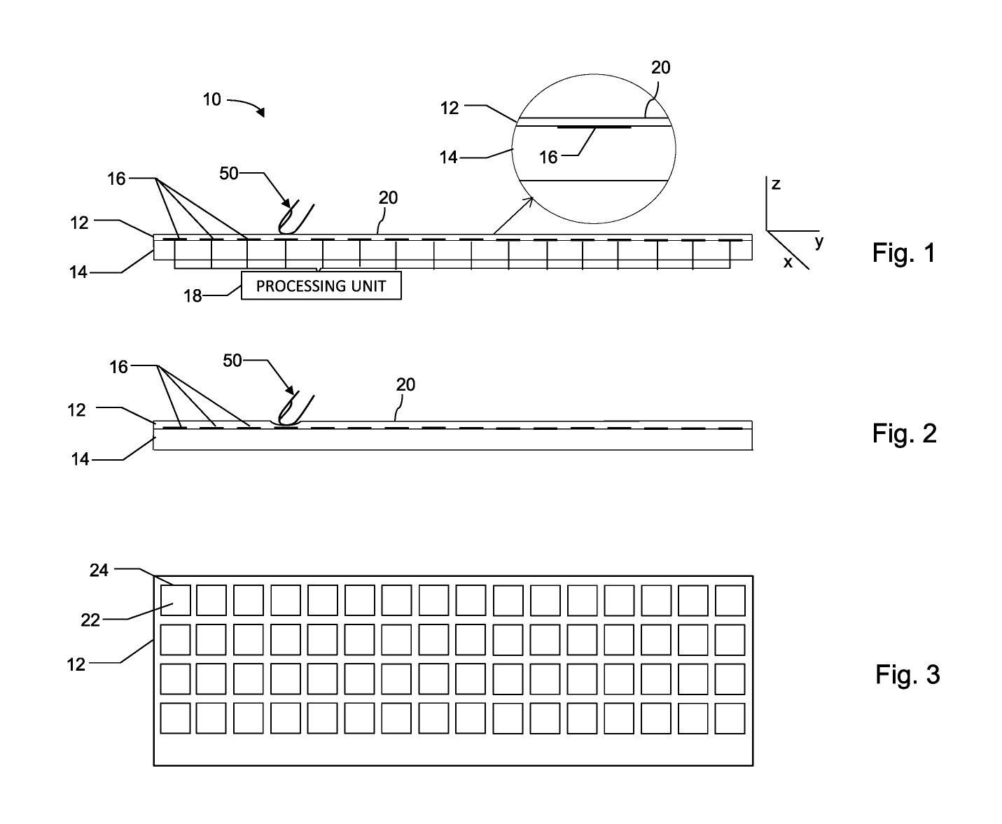

A dual-use keyboard is illustrated in FIGS. 1-3 and generally designated 10. The dual-use keyboard 10 generally includes a touch substrate 12, a support substrate 14, a plurality of electrodes 16 between the touch substrate 12 and the support substrate 14, and a processing unit 18 coupled to the output of the plurality of electrodes 16. The touch substrate 12 is generally depressible in the present embodiment. That is, the touch substrate 12 is adapted to locally compress, or deflect downwardly at the location of a touch event, as perhaps best shown in FIG. 2. The depressible touch substrate 12 is elastically deformable, returning to its original shape after the removal of an object (e.g., a finger or a stylus) from the touch substrate 12. Optional materials for the touch substrate 12 include a shape-memory polymer, for example polyurethane shape memory polymer or vinyl foam material. Other materials may be used in other embodiments where desired, including both transparent and opaque materials.

The touch substrate 12 is substantially continuous in the present embodiment, defining a touch surface 20 (e.g., an upper major surface) that is generally free of indentations or protrusions. In other embodiments, however, the touch substrate 12 can include a discontinuous touch surface 20, optionally including channels or indentations between adjacent keys 22. As used herein, the touch surface 20 is the exposed upper portion of the keyboard 10. The touch substrate 12 can be formed of a single material in some embodiments, while in other embodiments the touch substrate 12 includes a layered combination of materials, including for example an outer protective film, the outer surface of which constitutes the touch surface 20. In addition, the touch substrate 12 and the touch surface 20 include a plurality of keys 22 integrally formed therein. The keys 22 can be indicated with suitable indicia, including for example printed lettering or numbering. In embodiments where the touch substrate 12 is transparent, the visual indicia can be generated from below the touch substrate 12, coinciding with placement of each virtual key. In addition, the visual indicia can include an outline 24 that delimits each key from the adjacent key as illustrated in FIG. 3, such that each key 22 is visually spaced apart from the adjacent key 22.

As noted above, the keyboard 10 includes a plurality of electrodes 16 positioned between the touch substrate 12 and the support substrate 14. The electrodes 16 or “sense electrodes” are formed from a conductive material, being generally positioned beneath the plurality of keys 22. In some embodiments, the sense electrodes 16 are coextensive with the area of the overlying key 22. For example, the sense electrodes 16 can have a generally square-shaped geometry in the embodiment illustrated in FIG. 1, while the sense electrodes 16 can assume other geometries in other embodiments where desired. The sense electrodes 16 are electrically isolated from one another, each including an output that is electrically coupled to the processing unit 18. The sense electrodes 16 can be constructed of any conductive or substantially conductive material, including copper, silver ink, nanowire, or indium tin oxide.

The support substrate 14 is generally coextensive in area with the touch substrate 12 to support both of the electrodes 16 and the touch substrate 12 thereon. The support substrate 14 includes an upper major surface that directly supports the sense electrodes 16, where a bottom surface of the sense electrodes 16 directly engages the upper major surface of the support substrate 14. In another embodiment, the sense electrodes 14 are mounted to the lower major surface of the touch substrate 12, opposite of the touch surface 20. In still another embodiment, the sense electrodes 16 can be mounted to an intermediary substrate that is laminated or adhered to the touch substrate 12 or to the support substrate 14. The support substrate 14 is substantially rigid at room temperature in the present embodiment, while in other embodiments the support substrate 14 is flexible at room temperature. The support substrate 14 can be formed of a printed circuit board material, glass, sapphire, paper or other materials as desired.

As noted above, the processing unit 18 is coupled to the output of the plurality of sense electrodes 16. The processing unit 18 is generally adapted to determine the presence of a touch event based on the capacitance of one or more of the plurality of sense electrodes 16. Further optionally, the processing unit 18 is generally adapted to determine the presence of a touch event based on the rate of change of the capacitance of one or more of the plurality of sense electrodes 16. More generally, the keyboard 10 can include essentially any electrode structure, any processing unit (both analog and digital), and any measurement circuit (both analog and digital) set forth in the following disclosures incorporated by reference: U.S. Patent Application Publication 2012/0068760 to Caldwell et al entitled “Apparatus and Method for Determining a Touch Input,” PCT Patent Application Publication WO2013/163496 to Caldwell et al entitled “Apparatus and Method for Determining a Stimulus, Including a Touch Input and a Stylus Input,” U.S. Provisional Application 61/875,961 to Caldwell et al entitled “Time Domain Differential Techniques to Characterize Various Stimuli,” and U.S. Provisional Application 61/947,641 to Caldwell entitled “Simultaneous Sensing Circuits for Time Domain Differential and Other Electric Field Sensing.”

When an object 50 has substantially compressed the touch substrate 12, or compressed the touch substrate 12 to a predetermined depth, as shown in FIG. 2, the processing unit 18 operates in either of the keypad mode or the touchpad mode. In the present embodiment, the processing unit 18 operates in a keypad mode when the predetermined deflection is achieved. In other embodiments, the processing unit 18 operates in the touchpad mode when the predetermined deflection is achieved. When an object 50 has not substantially compressed the touch substrate 12, the processing unit 18 operates in the other of the keypad mode and touchpad mode. In both modes of operation, the processing unit 18 is operable to determine the x-y location(s) of a touch event on the keyboard 10. As used herein, a “touch event” includes singular touch inputs and continuous touch inputs. A singular touch input includes placement of an object against the keyboard 10, generally approaching the keyboard from a direction orthogonal to the keyboard surface 20. The singular touch input can indicate a key selection in “keypad mode,” and can indicate a left or right mouse button selection in “trackpad mode.” A continuous touch input includes movement of an object along the keyboard 10, in a direction generally parallel to the keyboard surface 20. The continuous touch input is typically (though not necessarily) only recognized in “trackpad mode,” and can indicate a variety of functions, including cursor control, swipe, scroll, pan, rotate, and fling, including multi-touch variations of the same.

The determination of whether the object 50 has compressed the touch substrate to a predetermined depth can be performed by the processing unit 18 according to a number of methods, including both capacitive methods and time domain differential sensing methods. According to a capacitive method, predetermined capacitive set-point values are used, being stored in computer readable memory accessible to the processing unit 18. According to this method, the processing unit 18 measures the capacitance of each sense electrode 16. The processing unit 18 compares the measured capacitance for each sense electrode 16 with first and second predetermined set-point values. The first set-point value corresponds to placement of an object (e.g., a finger) against (but not into) the touch surface 20. The second set-point value corresponds to placement of the object a predetermined depth into the touch surface 20. The second set-point value is generally greater than the first set-point value. That is, the electrode capacitance does not normally meet the second set-point value when the touch substrate 12 is not compressed. However, the electrode capacitance does normally meet the second set-point value when the touch substrate 12 is compressed. The processing unit 18 determines the mode of operation (touchpad mode or keypad mode) based on whether the first set-point value is met (touchpad mode) or whether both set-point values are met (keypad mode). The processing unit 18 then determines the x-y location of a singular touch input or a continuous touch input based on the location of the electrode(s) 16 registering the greatest capacitance, optionally interpolating x-y location between keys.

According to a time domain differential sensing method, the processing unit 18 additionally determines the rate of change of electrode capacitance. By determining when the rate of change of electrode capacitance has decreased to zero, or substantially zero, the processing unit 18 determines a) when an object 50 has come to rest relative to the underlying electrode in the z direction and/or b) when an object 50 has crossed over the underlying electrode in the x-y direction. This determination can include a comparison of the rate of change with a threshold value, which is different from the set-point values noted above. When the rate of change of the sense electrode capacitance falls below the threshold value, being substantially zero, the processing unit 18 determines the object 50 a) has come to rest relative to the underlying electrode in the z direction and/or b) has crossed over the underlying electrode in the x-y direction. The processing unit then compares the absolute value of the sense electrode capacitance (measured at the time the capacitance falls below the threshold value) with one or more set-point values substantially as described above. That is, the first set-point value can correspond to placement of a finger against (but not into) the touch surface 20, and the second set-point value can correspond to placement of a finger into the touch surface 20. The processing unit 18 determines the mode of operation (touchpad mode or keypad mode) based on whether the first set-point value is met (touchpad mode) or whether both set-point values are met (keypad mode). The processing unit 18 then determines the x-y location of a singular touch input or a continuous touch input based on the location of the key(s) registering the greatest capacitance, optionally interpolating x-y location between keys.

As noted above, the present disclosure addresses the application of time domain differential sensing for standard keyboards. The keyboard 10 may be used with capacitive and projected capacitive techniques even though the use of time domain differential may result in a more reliable method of sensing. The keyboard 10 of the present embodiment is illustrated with sixty-four inputs, but can be implemented with greater or fewer keys as desired. For example, the keyboard 10 can be implemented with twelve inputs, optionally for a mobile phone. This would allow a mobile phone to utilize gesture and interpolation for the display without the added expense of a touch screen (e.g., no indium tin oxide).

To reiterate, when the touch substrate is not compressed, the processing unit 18 would sense the touch at the touch surface 20 of the touch substrate 12. Using time domain differential sensing, the processing unit 18 can indicate x-y location similar to a touch screen with gesture interpretation and interpolated x-y location on the keyboard. When the touch substrate is compressed, a three dimensional value that may be interpreted as keyboard input that is separate from a gesture/interpolation signature algorithm. Also, the opposite may be implemented where the keyboard input would only happen when a touch without compression is implemented and when the compression of the touch substrate occurs, a gesturing/interpolation algorithm would be implemented.

II. Alternative Keyboard Constructions

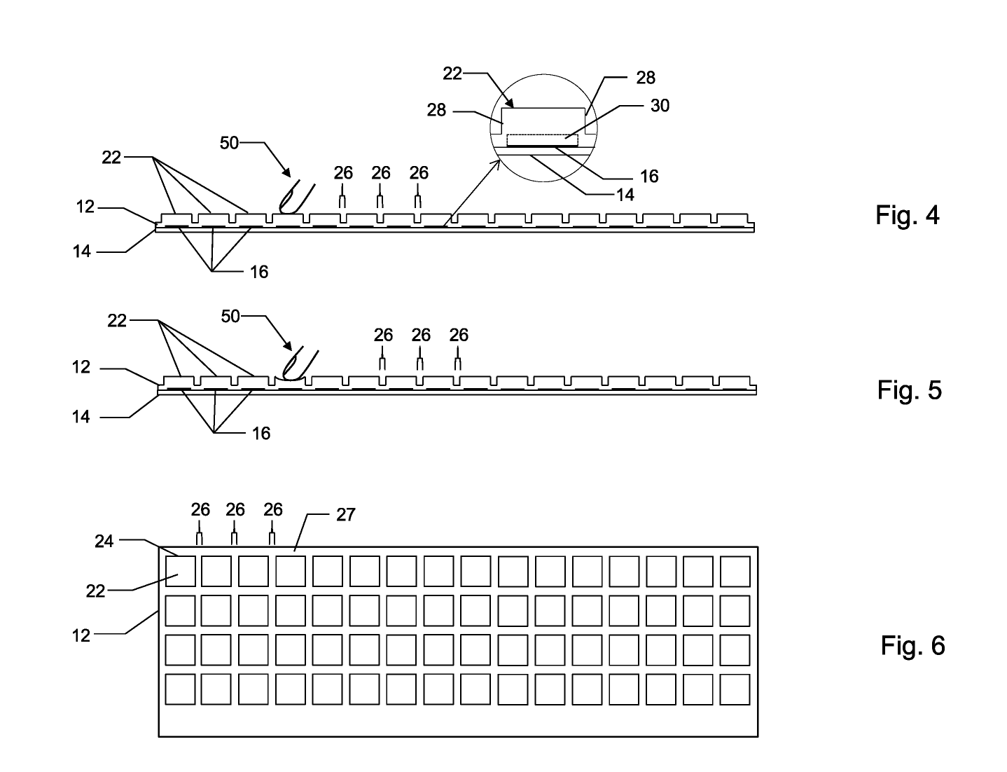

FIGS. 4-24 illustrate various alternative keyboard constructions in accordance with embodiments of the present invention. The keyboards illustrated in FIGS. 4-24 are similar to the keyboard 10 of FIGS. 1-3 in that the keyboards of FIGS. 4-24 are operable in a touchpad mode and operable in a keypad mode based on the degree of deflection of a depressible touch substrate. The processing unit 18 is not shown for succinctness in FIGS. 4-24, but is electrically connected to the output of the electrodes as optionally depicted in FIG. 1.

The keyboard illustrated in FIGS. 4-6 differs from the keyboard 10 illustrated in FIGS. 1-3 in that the touch substrate 12 includes a gap 26 (e.g., recess, channel, indentation) between adjacent ones of the plurality of keys 22. Each key 22 includes a sidewall 28 (e.g., planar or arcuate) that is spaced apart from an adjacent key sidewall 28 by an amount equal to the width of the gap 26. The keys 22 are generally raised from a surface 27 of the touch substrate 12, such that no two keys 22 are in direct physical contact with each other. As further optionally shown in FIG. 4, each key 22 can include a fluid pocket 30. The fluid pocket 30 includes air in the present embodiment, but can include other liquids, gases, or gels in other embodiments. The fluid pocket 30 is entirely encapsulated within the key 22 in the present embodiment. When the key 22 is compressed, the distance for sensing decreases, as the dielectric constant of the key 22 would change from a coefficient of 1 (for air) to the coefficient of the material forming the touch substrate 12. The fluid pocket 30 can thereby cause a greater change in electrode capacitance when trying to detect a touch event in the z-dimension (e.g., downward movement).

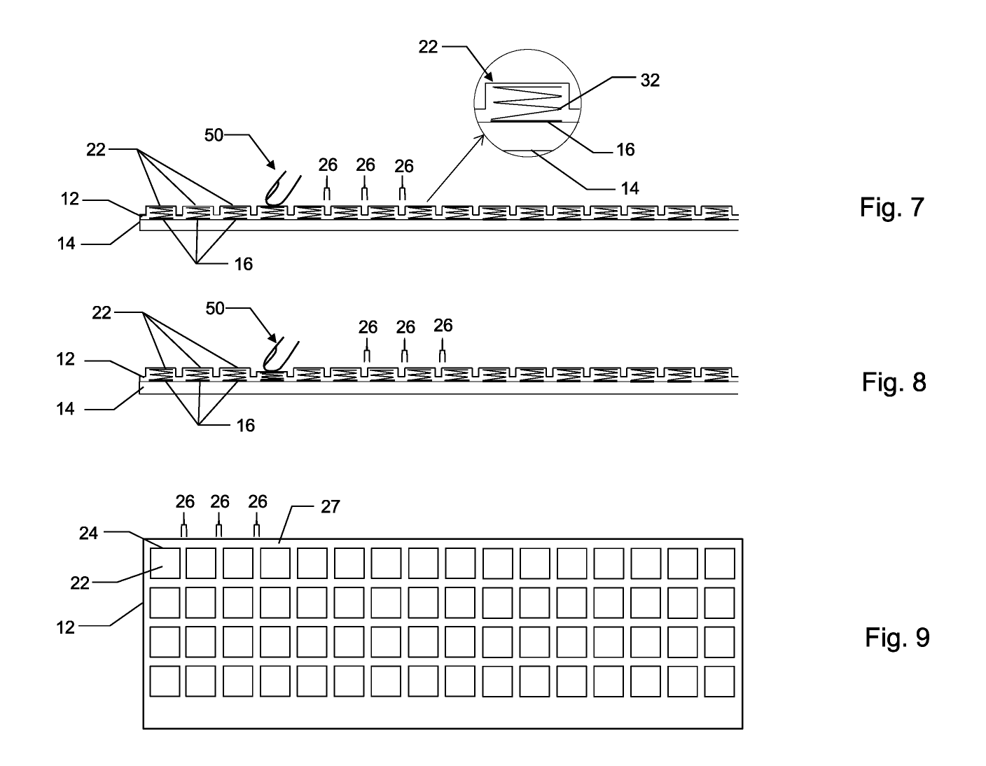

The keyboard illustrated in FIGS. 7-9 differs from the keyboard illustrated in FIGS. 4-6 in that each key 22 includes an internal compression spring 32, rather than a fluid pocket 30. The compression spring 31 is formed from a dielectric material in the present embodiment, being self-contained within the key 22 and oriented with a compression axis in the z-direction. The compression spring 32 is positioned above the sense electrode 16 in the present embodiment, but can be positioned below the sense electrode 16 in other embodiments. The touch substrate 12 is optionally formed by molding a depressible touch substrate material around the compression springs 32.

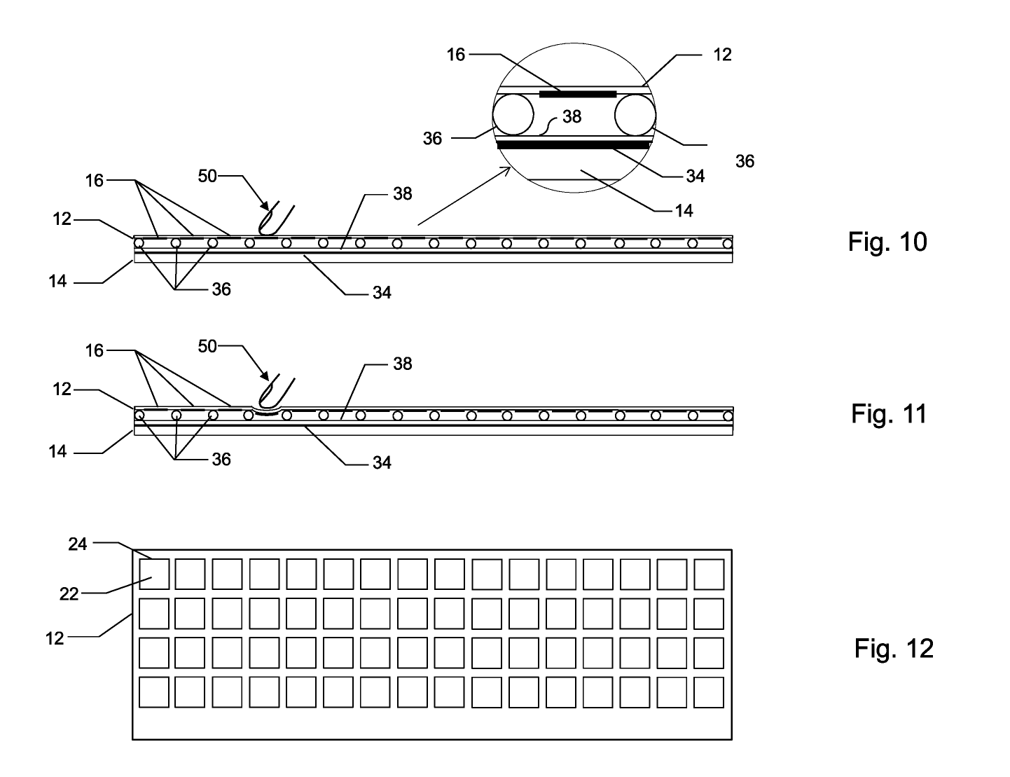

The keyboard illustrated in FIGS. 10-12 differs from the keyboard 10 illustrated in FIGS. 1-3 in that the keyboard in FIGS. 10-12 includes a bias electrode 34 and spacers 36. In this embodiment, the sense electrodes 16 are integrated into the flexible touch substrate 12. The bias electrode 34, which is shown as integrated into the support substrate 14 and separated from the sense electrodes 16 by spacers 36, provides an additional stimulus for time domain differential sensing. The spacers 36 are substantially rigid, underlying the gap 26 between adjacent keys 22. An optional protective dielectric film or layer 38 is positioned between the bias electrode 32 and the spacers 36. When an object 50 is applied at the touch substrate 12, touch sensing occurs as described in Part I above. Gesturing/interpolation may take place or conversely a key input may be processed. When the touch substrate 12 is flexed due to increased pressure by the object 50, shown in FIG. 11, one or more sense electrodes 16 moves closer to the bias electrode 34. The bias electrode 34 can be at ground potential, a DC potential, or a periodic signal, for example. This bias potential creates an additional stimulus when the touch substrate 12 moves towards the bias electrode 34. A key input 22 can be processed when the touch substrate 12 is flexed, and gesturing/interpolation can take place when the touch substrate 12 is touched but not flexed. The opposite can also be implemented. That is, gesturing/interpolation can take place when the touch surface 12 is flexed, and a key input 24 can be processed when the touch substrate 12 is touched but not flexed.

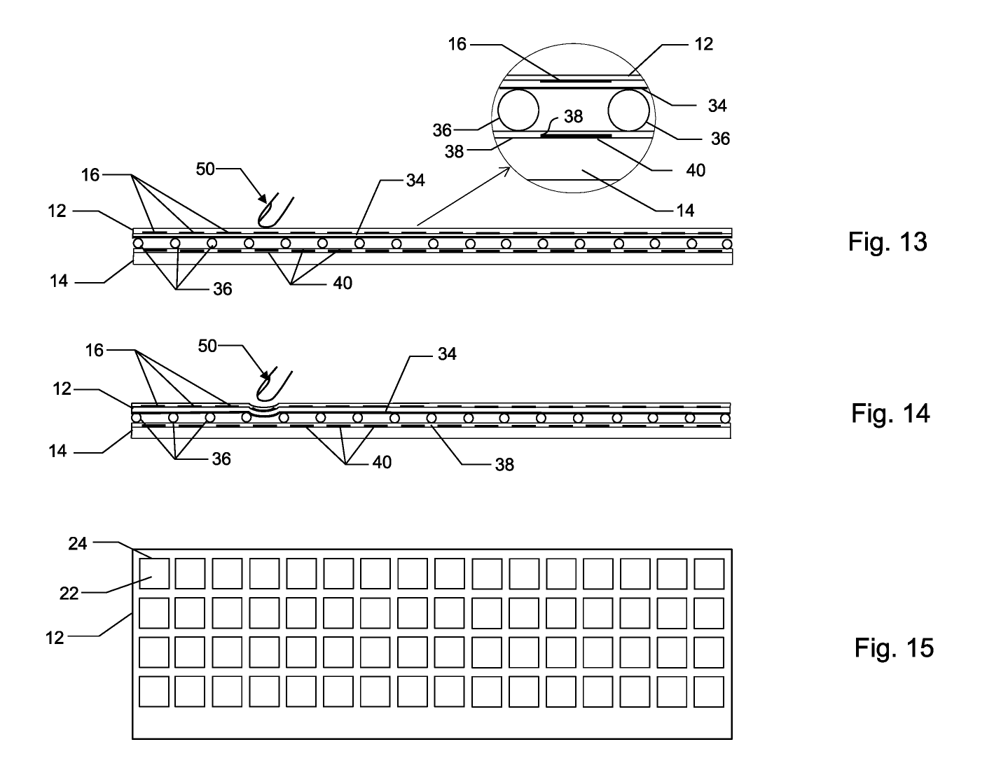

The keyboard illustrated in FIGS. 13-15 differs from the keyboard illustrated in FIGS. 10-12 in that the keyboard in FIGS. 13-15 includes a second plurality of sense electrodes 40. The first plurality of sense electrodes 16 is supported at the touch substrate 12, and the second plurality of sense electrodes 40 is supported at the support substrate 14, where both pluralities 16, 40 are electrically coupled to the processing unit 18. The bias electrode 34 is further optionally supported by the touch substrate 12. The bias electrode 34 is optionally at ground potential. The first plurality of sense electrodes 16 can measure a touch event independent of the second plurality of electrodes 40 by not mutually coupling to each other. Similarly, the second plurality of sense electrodes 40 can measure a touch event independent of the first plurality of electrodes 40. The first plurality of sense electrodes 16, the second plurality of sense electrodes 40, and the bias electrode 34 are each electrically isolated from each other. For example, the first and second plurality of sense electrodes 16, 40 are separated from each other by the spacers 36 between the support substrate 14 and the touch substrate 12. An optional dielectric material 38 can be added to either substrate 12, 14 to prevent shorting out of the bias electrode 34 to the second plurality of sense electrodes 40. The bias electrode 34 and the second plurality of sense electrodes 40 can be used to implement conventional switching techniques or analog resistive touch sensing. Accordingly, an advantage of the construction shown in FIGS. 13-15 is that the first plurality of sense of electrodes 16 is able to respond completely independently from the second plurality of sense electrodes 40, both being electrically isolated from each other by the bias electrode 34.

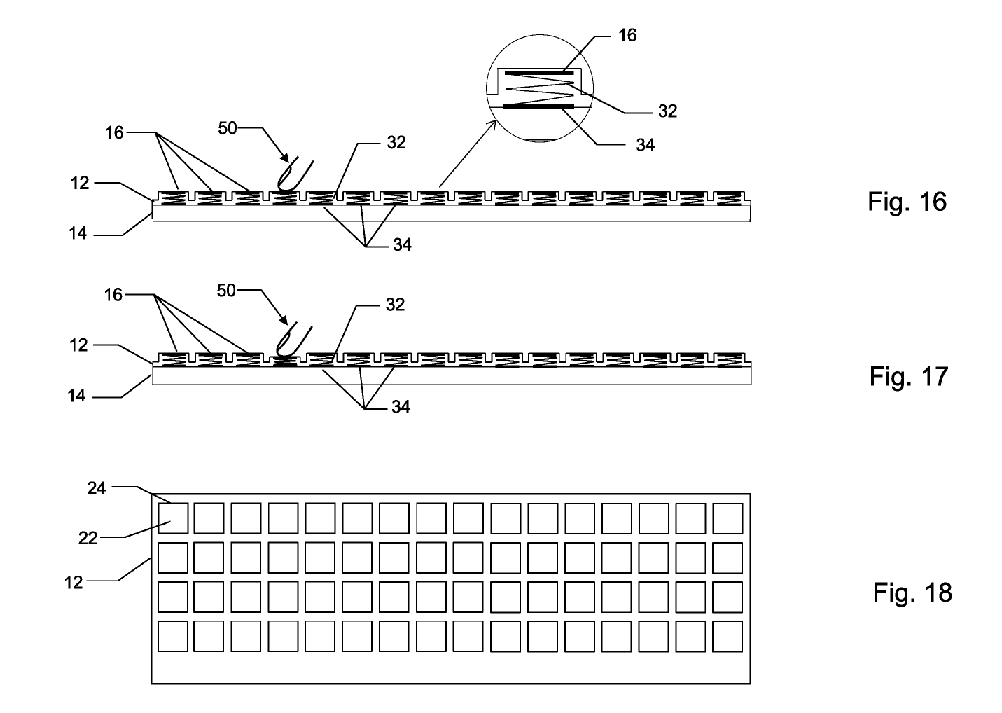

The keyboard illustrated in FIGS. 16-18 differs from the keyboard illustrated in FIGS. 7-9 in that the keyboard in FIGS. 16-18 includes a bias electrode 34 beneath the compression spring 32 and a sense electrode 16 above the compression spring 32. In particular, the bias electrode 34 is located within the touch substrate 12 beneath the compression spring 30, which is generally made of a dielectric material or non-conductive material. The sense electrode 16 is located near the touch surface 20. The sense electrode 16 can be used to sense key inputs and touch gestures as described above. The bias electrode 34 can provide an additional stimulus to the sense electrode 16 as the user depresses the touch surface 20 and compresses the spring 30, thereby sensing z-input information.

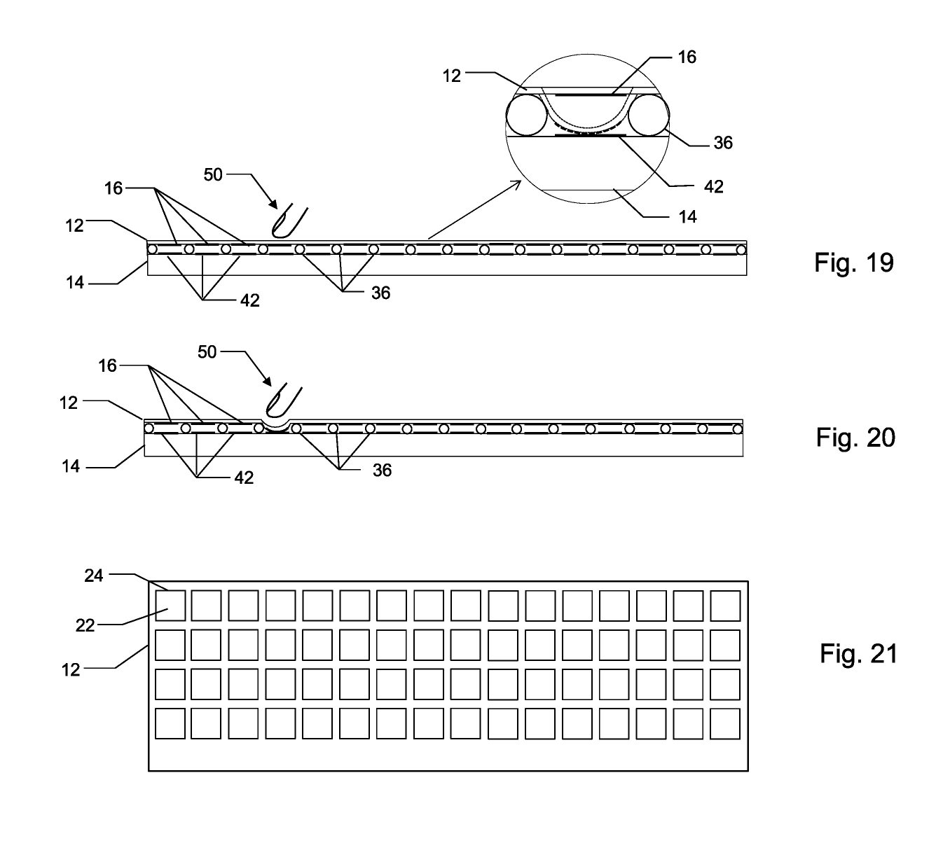

The keyboard illustrated in FIGS. 19-21 differs from the keyboard illustrated in FIGS. 1-3 in that the keyboard in FIGS. 19-21 includes an electro-mechanical switch for at least one key 22, and further optionally each key 22. The sense electrodes 16 are supported at the touch substrate 12, which is spaced apart from the support substrate 14 by spacers 36. A plurality of switch contacts 42 are supported at the support substrate 14. As the flexible touch substrate 12 is depressed, the sense electrode 16 contacts the switch contact 42. At this point in time the sense electrode indicates a switch input, which is processed by the processing unit 18. This type of implementation can provide two distinct sensing techniques, one for the touch gestures and the other for the key selection.

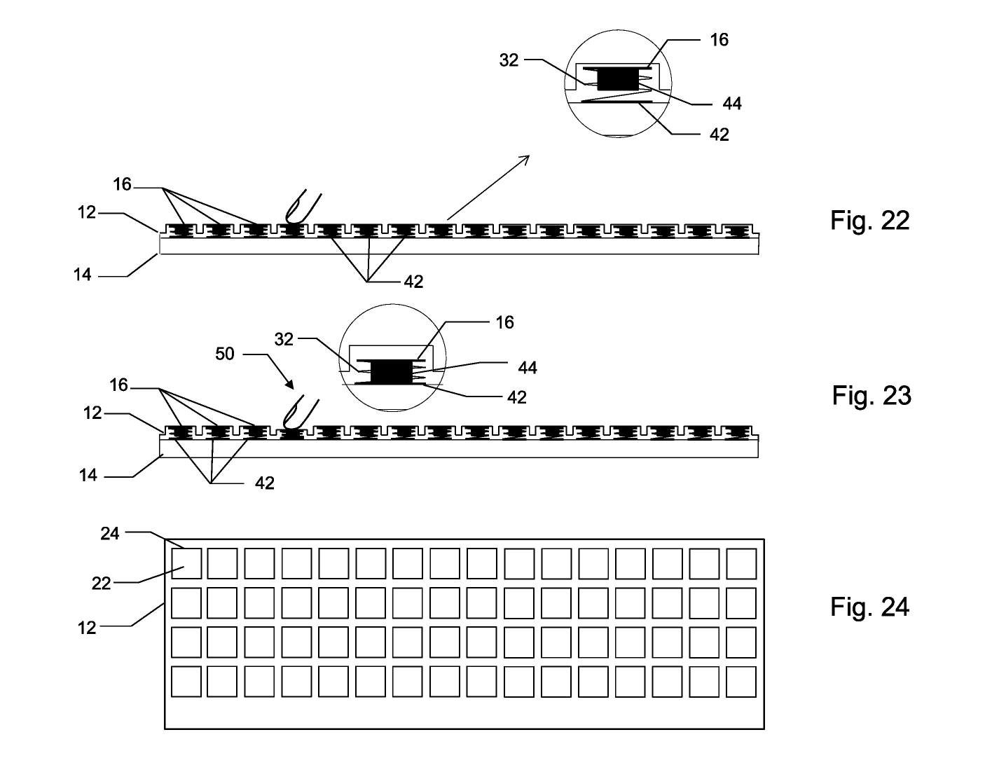

The keyboard illustrated in FIGS. 22-24 similarly includes an electro-mechanical switch. In particular, the sense electrode 16 includes a post 44 to engage the switch contact 42. The post 44 has a thickness in the z-direction to decrease the distance between the sense electrode 16 and the switch contact 42. The compression spring 30 is optionally constructed of a dielectric material. Again, as described in FIGS. 19-20, when an object is applied to the touch surface 20 near the sense electrode 16, a touch event can be detected, including singular touch input (e.g., a tap) and continuous touch input (e.g., a swipe). As the key 22 is depressed, eventually the sense electrode 16 contacts to the switch contact 42. At this point in time the sense electrode 16 indicates a switch input, which is processed by the processing unit 18. This implementation can provide two distinct sensing techniques, one for the touch gestures and the other for the key selection.

Any of the time domain differential sensing techniques described in disclosures incorporated by reference above may be used in connection with the keyboards described above in connection with FIGS. 1-24. Capacitance sensing techniques may also be used. The features of the keyboards described above can be implemented in combination with each other as desired. In addition, the above embodiments include a compressible touch substrate, and the degree of force in the z-direction results in various degrees of compression of the touch substrate. In a modification of the above embodiments, the touch substrate is substantially rigid and is supported above the support substrate by resilient elements, for example compressible spacers or compression springs. Accordingly, the degree of force in the z-direction results in various degrees of compression of the compressible spacers, rather than various degrees of compression of the touch substrate. In a modification of the embodiment of FIGS. 10-12 for example, the spacers 36 are formed of a resilient material, for example polyurethane shape memory polymer or compression springs, and the touch substrate 12 is formed of a substantially rigid material, for example glass. The processing unit 10 detects movement of an object against the touch substrate 12 and movement of an object along the touch substrate 12, optionally based on capacitance and rate of change of capacitance as set forth above. The processing unit 10 classifies such movement as a key selection (in keypad mode) or as a touch gesture (in trackpad mode) based on the amount of deflection of the touch substrate 12 toward the support substrate 14. When an object 50 has substantially compressed the spacers 36, or displaced the touch substrate 12 in the z-direction toward the support substrate 14 by a predetermined distance 9 (e.g., at least 3 mm), the processing unit 18 operates in the keypad mode (or alternatively the touchpad mode). When an object 50 has not substantially compressed the spacers 36, or has not displaced the touch substrate 12 in the z-direction toward the support substrate 14 by a predetermined distance (e.g., at least 3 mm), the processing unit 18 operates in touchpad mode (or alternatively keypad mode). In both modes of operation, the processing unit 18 is operable to determine the x-y location(s) of a touch event on the keyboard 10, including singular touch inputs (e.g., a single tap of the touch substrate 12) and continuous touch inputs (e.g., a swipe of the touch substrate 12). The singular touch input can indicate a key selection in keypad mode, and can indicate a left or right mouse button selection in trackpad mode. A continuous touch input includes movement of an object along the touch substrate 12, in a direction generally parallel to the keyboard surface 20. The continuous touch input is typically (though not necessarily) only recognized in trackpad mode, and can indicate a variety of functions, including cursor control, swipe, scroll, pan, rotate, and fling, including multi-touch variations of the same. The sense electrodes 16 in this embodiment can be supported at the support substrate 14 or at the touch substrate 12 with a bias electrode 32.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. Any reference to elements in the singular, for example, using the articles “a,” “an,” “the,” or “said,” is not to be construed as limiting the element to the singular.

1. A keyboard device comprising:
a support substrate;
a compressible touch substrate extending over the support substrate and including a plurality of keys integrally formed therein;
a plurality of electrodes between the support substrate and the compressible touch substrate, each of the plurality of electrodes having an output; and
a processing unit coupled to the output of the plurality of electrodes, wherein the processing unit is adapted to:
detect the deflection of the compressible touch substrate based on the output of the plurality of electrodes, and
operate in a keypad mode or a touchpad mode based on the measured deflection.

2. The keyboard device of claim 1 wherein the processing unit is adapted to measure the capacitance of the plurality of electrodes.

3. The keyboard device of claim 1 wherein the processing unit is adapted to measure the rate of change of capacitance of the plurality of electrodes.

4. The keyboard device of claim 1 wherein each of the plurality of keys includes a resilient element therein.

5. The keyboard device of claim 1 further including a bias electrode positioned between the plurality of electrodes and the support substrate.

6. The keyboard device of claim 1 wherein the touch substrate defines a plurality of channels between adjacent ones of the plurality of keys.

7. A method comprising:
providing a compressible touch substrate including a plurality of keys integrally formed therein;
providing a plurality of electrodes proximate the touch substrate, each of the plurality of electrodes including an electrode capacitance;
measuring a change in the electrode capacitance of at least one of the plurality of electrodes in response to a touch event;
determining a deflection of the compressible touch substrate based on the change in electrode capacitance; and
distinguishing between a key selection and a touch gesture based on the deflection of the compressible touch substrate.

8. The method according to claim 7 wherein the touch event includes at least one of a singular touch input and a continuous touch input.

9. The method according to claim 8 wherein the singular touch input includes movement of an object against the touch substrate.

10. The method according to claim 8 wherein the continuous touch input includes movement of an object along the touch substrate.

11. The method according to claim 7 wherein the touch substrate includes a substantially continuous touch surface.

12. The method according to claim 7 wherein the plurality of keys are spaced apart from each other.

13. The method according to claim 7 wherein the touch substrate is formed of a shape memory material.

14. The method according to claim 7 wherein each of the plurality of keys includes a resilient element disposed therein.

15. A keyboard device comprising:
a support substrate including a plurality of electrodes positioned along a major surface thereof, each of the plurality of electrodes having an output;
a depressible touch surface including a plurality of keys integrally formed therein, wherein each of the plurality of keys overlies one of the plurality of electrodes; and
a processing unit electrically coupled to the output of each of the plurality of electrodes, wherein the processing unit is adapted to:
measure a change in the output of at least one of the plurality of electrodes in response to a touch event on the touch substrate, and
determine, based on the measured change, whether the touch event includes a key selection or a touch gesture, wherein the touch gesture includes movement along the touch surface in a direction parallel to the touch surface or movement against the touch surface in a direction orthogonal to the touch surface.

16. The keyboard device of claim 15 wherein the touch surface includes a plurality of relief channels between adjacent ones of the plurality of keys.

17. The keyboard device of claim 15 wherein each of the plurality of keys includes a resilient element disposed therein.

18. The keyboard device of claim 17 wherein the resilient element includes at least one of a compression spring and a fluid pocket.

19. The keyboard device of claim 15 further including a bias electrode positioned between the support substrate and the touch substrate.

20. The keyboard device of claim 15 wherein each of the plurality of keys includes a switch contact.
